(19) United States
(12) Patent Application Publication
(10) Pub. No.: US 2007/0086125 A1
(43) Pub. Date: Apr. 19, 2007

(54) Elimination of DC ground fault currents in auto-transformer rectifier unit

(75) Inventor: Donal E. Baker, Rockford, IL (US)

Correspondence Address: CARLSON, GASKEY & OLDS, P.C., 400 WEST MAPLE ROAD, SUITE 350, BIRMINGHAM, MI, 48009, US

(73) Assignee: Hamilton Sundstrand Corporation

(21) Appl. No.: 11/253,325

(22) Filed: Oct. 19, 2005

(51) Int. Cl. H02H 9/08

(52) U.S. Cl. 361/42

(57) ABSTRACT

An auto-transformer rectifier unit includes circuitry for eliminating DC ground faults. Generally, a capacitor is added in series between each of the input AC feeder lines. Consequently a fault on a DC rail to ground or a faulted diode will prevent or eliminate a DC current ground fault condition entirely. It will, however, retain a significant (detectable) increase in current for differential faults, which would let the protective device trip the unit off line. Large magnitude fault currents are also eliminated.

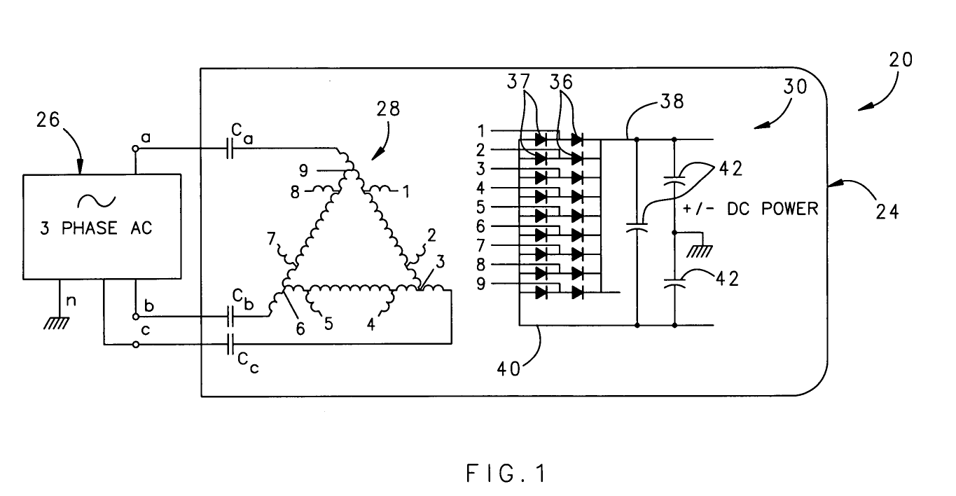

### BACKGROUND OF THE INVENTION

This invention relates to auto-transformer rectifier units and more particularly to the elimination of DC fault currents in auto-transformer units.

In some power system architectures, including aircraft applications, rectifier circuits are used to convert AC power to DC power. These power system architectures may also include a transformer, in which case the combined unit is referred to as a transformer rectifier unit. If the transformer is a non-isolating type, then it is called an auto-transformer rectifier unit (ATRU). Because the ATRU is not isolated, its transformer can be made lighter in weight and lower cost. However, it provides potential fault current paths that do not exist in an isolated transformer rectifier unit (TRU).

The ATRU is sometimes used to provide DC power for smaller motor drives for aircraft applications. One known ATRU applies a three-phase AC input to a transformer circuit. Nine nodes on the transformer are each connected to a high or positive rail by a diode and to a low or negative rail by another diode in the rectifier circuit. A fault on a rail to ground gives rise to excessive DC currents which are difficult to interrupt and can be very large in magnitude. Arcing can cause structural damage. Additionally, the DC ground fault currents pass through the generator neutral connection and can cause the generator and its voltage regulator and protective circuits to malfunction leading to undesirable system consequences.

### SUMMARY OF THE INVENTION

The present invention eliminates DC ground fault currents in an auto-transformer rectifier unit of the type described above. Generally, a capacitor is added in series between each of the input AC feeder lines. Consequently a fault on a DC rail to ground or a faulted diode will prevent or eliminate a DC current ground fault condition entirely. It will, however, retain a significant (detectable) increase in current for differential faults, which would let the protective device trip the unit off line. Large magnitude fault currents are also eliminated.

### BRIEF DESCRIPTION OF THE DRAWINGS

Other advantages of the present invention can be understood by reference to the following detailed description when considered in connection with the accompanying drawings wherein:

The Figure is a schematic illustrating the DC ground fault elimination circuit in use with an auto-transformer rectifier unit.

### DETAILED DESCRIPTION OF THE PREFERRED EMBODIMENTS

A power system 20 is illustrated in the Figure. The power system includes an auto-transformer rectifier unit (ATRU) 24. The ATRU 24 provides DC power from an AC input, in this case a three-phase AC power source 26, generating three sine-wave phase a-c voltages with its neutral connected to ground. The ATRU 24 includes a transformer 28 and a rectifier 30.

The transformer 28 includes a plurality of phase-separated nodes 1-9 connected via varying impedances to the three sine-wave phases a-c of the AC power source 26. The transformer 28 thus generates a nine-phase output from the three-phase input of the AC power source 26. The rectifier 30 includes a plurality of first or high diodes 36, each connecting one of the nodes 1-9 of the transformer 28 to a high rail 38 in the rectifier 30. The rectifier 30 also includes a plurality of second or low diodes 37 connecting each of the nodes 1-9 to a low rail 40. Capacitors 42 may further smooth the signal by connecting the high rail 38 to the low rail 40 and by connecting the rails 38, 40 to ground.

In order to eliminate DC ground fault currents, a capacitor Cₐ, C_{b}, C_{c} is connected in series with each of the outputs a, b, c, respectively, of the AC power source 26. The values of the capacitors Cₐ, C_{b}, C_{c} will depend upon the particular application. As an example, if the AC power source 26 is a 1000 VA, three-phase motor drive (e.g. for a fan), the rated current for this drive would be 1.45 amps for a 230 VAC line-to-neutral supply. The rated impedance would be 159 ohms per phase. A 1PU capacitance, based on 400 Hz bottom frequency would be 2.5 uF. Different sizes of capacitors Cₐ, C_{b}, C_{c} can be used, but preferably a one-third PU impedance capacitor is selected for each of the capacitors Cₐ, C_{b}, C_{c}. That would be three times the 1 PU value or 7.5 uF per phase. With this value, at 400 Hz, the 1 kVA motor drive would have a somewhat reduced DC input voltage (very slight: about 5%, where sqrt (1²+0.33²)=1.05 PU Ohms total input impedance with the series cap. At 800 Hz, the droop would be less than 2%. A worst case hard fault (the capacitor shorted to ground) results in a 3 PU current on that phase which would be 1.45*3=4.35 amps rms for 400 Hz. At 800 Hz this same fault would be double that current or 8.7 amps rms. These are detectable and safe levels.

The capacitors Cₐ, C_{b}, C_{c} will not adversely affect the ATRU 24 during normal operation because the harmonics involved with the ATRU 24 are much higher than fundamental and at those frequencies the capacitor impedance becomes vanishingly small. The current in the capacitors Cₐ, C_{b}, C_{c} is relatively small (1.45 amps rms nominal and 8.7 amps for worst case fault) and there are many relatively small film capacitors that will work for this application.

If it is determined that three times capacitance is not enough, a ten times capacitor (25 uF in this 1 kVA example) could be used. At 400 Hz a 25 uF capacitor Cₐ, C_{b}, C_{c} would let the voltage to the motor drive input droop by only a half percent, a negligible amount. A worst case fault current would be a ten times current at 400 Hz, or 14.5 amps rms. At 800 Hz, the fault current would be double that, or 29 amps rms. Again, preferably a capacitor Cₐ, C_{b}, C_{c} that is between three times and five times the one PU value is preferred for the smaller ATRU 24 front-end motor drives.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope. Alphanumeric identifiers in method steps are for ease of reference in dependent claims and do not signify a required sequence unless otherwise indicated in the claim.

What is claimed is:

1. A power system comprising:
a transformer having a plurality of input nodes and a plurality of output nodes, a capacitor connected in series with each of the input nodes; and
a rectifier having a plurality of first diodes, each connecting one of the plurality of output nodes to a rectifier rail.

2. The power system of claim 1 wherein the rectifier rail is a high rectifier rail, the rectifier further including a plurality of second diodes, each connecting the output nodes to a low rectifier rail.

3. The power system of claim 2 further including an AC power source connected to the input nodes of the transformer with its neutral connected to ground.

4. The power system of claim 3 wherein the AC power source is a 3-phase AC power source.

5. The power system of claim 4 wherein the plurality of nodes includes nine nodes, such that the transformer generates a nine phase output on the nine nodes.

6. The power system of claim 1 wherein the transformer and rectifier comprise an auto transformer rectifier unit.

7. The power system of claim 1 wherein each of the capacitors is approximately one-third PU impedance.

8. The power system of claim 1 wherein each of the capacitors is between one-third and one-tenth PU impedance.

9. A method for providing DC power including the steps of:
a) connecting each of a plurality of capacitors to one of a plurality of phases of a multi-phase AC source; and
b) connecting each of the plurality of capacitors to one of a plurality of input nodes in an auto-transformer rectifier unit.

10. The method of claim 9 further including the step of selecting the plurality of capacitors to be approximately one-third PU impedance.

11. The method of claim 9 further including the step of selecting the plurality of capacitors to be between one-third PU and one-tenth PU impedance.

12. The method of claim 10 wherein the auto-transformer rectifier unit includes a transformer having a plurality of phase-separated output nodes.

13. The method of claim 12 wherein the auto-transformer rectifier unit includes a rectifier having a plurality of diodes each connecting one of the plurality of output nodes of the transformer to a rectifier rail.

14. A power system including:
a multi-phase AC source generating a plurality of phases;
a transformer having a plurality of input nodes, each connected to one of the plurality of phases of the AC source by a capacitor, the transformer connecting the plurality of input nodes to a plurality of phase-separated output nodes; and
a rectifier rectifying the plurality of phase-separated output nodes of the transformer.
